(19) United States
(12) Patent Application Publication
(10) Pub. No.: US 2020/0123424 A1
(43) Pub. Date: Apr. 23, 2020

(54) Instant drying crazy and super glue

(71) Applicant: Clayton L. Allen, Roseland, LA (US)

(72) Inventor: Clayton L. Allen, Roseland, LA (US)

(21) Appl. No.: 16/350,952

(22) Filed: Feb. 4, 2019

Related U.S. Application Data
(60) Provisional application No. 62/766,407, filed on Oct. 18, 2018.

(51) Int. Cl. C09J 11/08; C08L 1/12

(52) U.S. Cl. CPC C09J 11/08; C08L 1/12

(57) ABSTRACT

Using this product is as simple as counting to three! The package of glue should come with a super glue substance as well as cellulose acetate fiber, the plastic substance used in cigarette filters. The cellulose acetate fiber is placed where the glue will be needed prior to the glue. Once this is in place, you simply apply the glue over it. There should be a little smoke caused by the chemical reaction of the two substances creating instantly dried glue. It will be nearly impossible to separate the items that have been glued. You can even apply a small piece of tape behind the crack or use it to hold the two items together and keep everything in place.

Using krazy glue and super glue requires the objects being glued to be touching.

Using cellulose acetate fibre with super glue or krazy glue allows bigger projects to be completed, because when the substances are mixed together they dry instantly and provide a much stronger bond.

These projects can be completed within seconds. Users can say goodbye to the frustration of holding objects together and blowing on them for long periods of time just waiting for glues to do their job.

It's clear to see combining cellulose acetate fibre with super or krazy glue is the fastest, strongest, most logically way to go!

This is the fastest and easiest way to make quick fixes! There is no way to mess up, simply place cellulose acetate fibre between two objects needing to be glued before adding super glue or crazy glue. Just remember a more liquid base glue works better than a gel based glue. Gel based glues don't allow the cellulose acetate fibre to absorb it and react as necessary. Once applied together the bond will instantly be formed with a strong hold.

This reaction between these two substances is critical for the glue to dry in seconds, NOT minutes. It allows super glue and krazy glue to accomplish bigger task that were otherwise impossible. Using super or krazy glue alone is simply too messy and time consuming.

### Using Mr. Clayton's Instant Drying Glue

Using this product is as simple as counting to three! The package of glue should come with a super glue substance as well as cellulose acetate fibre, the plastic substance used in cigarette filters. The cellulose acetate fibre is placed where the glue will be needed prior to the glue. Once this is in place, you simply apply the glue over it. There should be a little smoke caused by the chemical reaction the two substances creating instantly dried glue that is nearly impossible to separate from the items that have been glued. You can even apply a small piece of tape behind the crack or use it to hold the two items together and keep everything in place.

This is a subtitle specification of the drawings

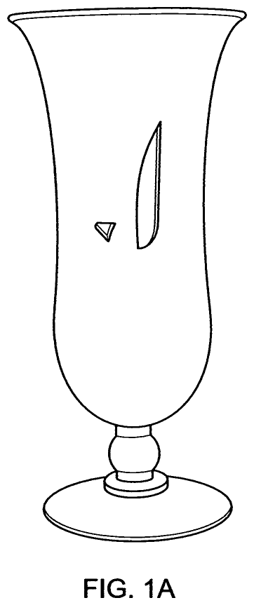

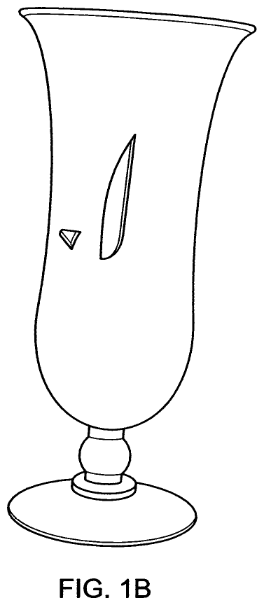

FIG. 1 A page 1 shows a busted cup with two holes in it. One hole is 5/16 by 2 inches and the other Hole ¼ inch triangler hole.

FIG. 1B page 2 shows a different angle of view of the same figure on page 1.

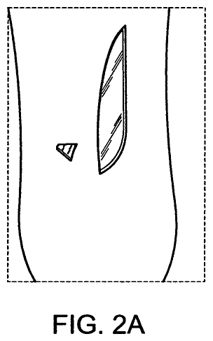

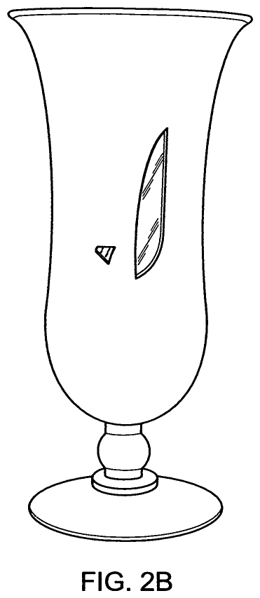

FIG. 2A page 3 shows step one put scotch tape on the back side of the hole when you can. This helps to hold things together.

FIG. 2B page 4 shows the same figure that is in 2A just a different view.

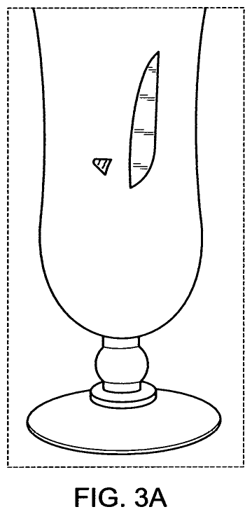

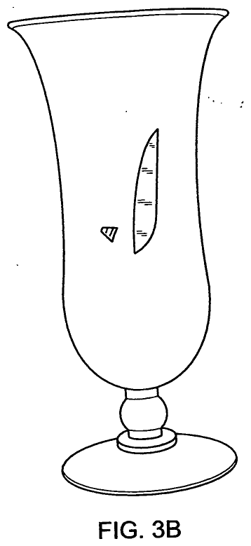

FIG. 3A page 5 shows step two put cellulose acetate, a plastic, into the cracks. Put it as thick as what you are repairing. It sticks to the tape and helps a lot in thin projects.

FIG. 3B page 6 just shows the same FIG. 3A at different views.

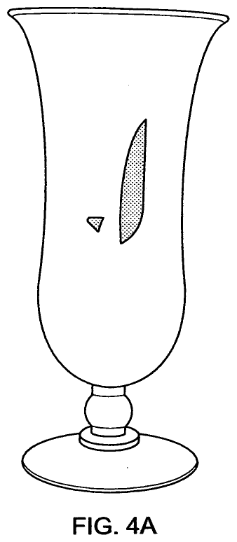

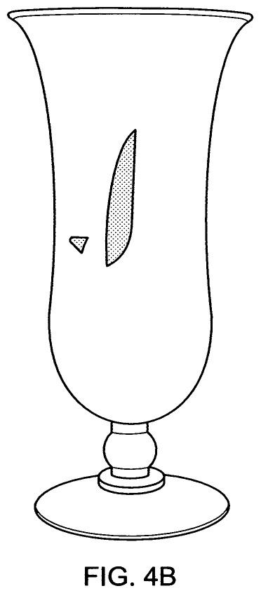

FIG. 4A page 7 shows step 3 lay down what you are repairing holes up if possible. Next apply crazy glue or super glue.

FIG. 4B page 8 shows the same figure as 4A just a different view.

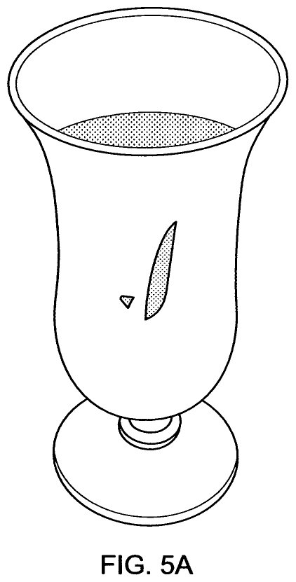

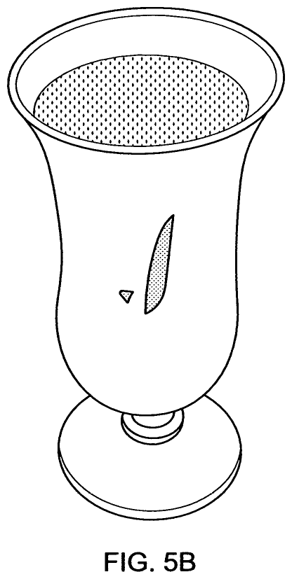

FIG. 5A page 9 shows the repaired glass holds water.

FIG. 5B shows the repaired glass holding red cream soda.

1. I claim that the reason cellulose acetate works fast with krazy glue and super glue is a simple fact that it is small pieces of plastic. This gives the glue more coverage at one time, which causes it to dry almost instantly. I believe that small pieces of plastic like a cigarette filter would work and cause the glue to react instantly and dry in just a few seconds. I claim that Krazy glue and Super glue and cellulose acetate make a strong and speedy repair of bigger projects.
